(19) United States
(12) Patent Application Publication
(10) Pub. No.: US 2007/0154693 A1
(43) Pub. Date: Jul. 5, 2007

(54) Non-metallic article and a method for making the same

(75) Inventors: Chien-Sung Tsai, Kaohsiung City (TW); Li-Hua Huang, Kaohsiung Hsien (TW); Ming-Huang Yang, Kaohsiung City (TW); Yi-Chung Chang, Kaohsiung Hsien (TW)

Correspondence Address: FOLEY AND LARDNER LLP;SUITE 500, 3000 K STREET NW, WASHINGTON, DC, 20007, US

(73) Assignee: ADVANCED INTERNATIONAL MULTITECH CO., LTD

(21) Appl. No.: 11/645,535

(22) Filed: Dec. 27, 2006

(30) Foreign Application Priority Data
Dec. 30, 2005 (TW) 094147493

(51) Int. Cl. B32B 3/00

(52) U.S. Cl. 428/209

(57) ABSTRACT

A non-metallic article includes a non-metallic substrate, a base coating, a metallic decorative coating, and a light-transmitting protective coating. The base coating includes a prime layer applied on the non-metallic substrate. The metallic decorative coating is deposited on the base coating, and includes a multi-color layer having a multi-color appearance. The multi-color layer is made of a cermet material produced by sputtering from a metal target using a gas mixture containing oxygen, nitrogen and hydrocarbon. The light-transmitting protective coating is applied on the metallic decorative coating.

### CROSS-REFERENCE TO RELATED APPLICATION

This application claims priority of Taiwanese application No. 094147493, filed on Dec. 30, 2005.

### BACKGROUND OF THE INVENTION

1. Field of the Invention

The invention relates to a non-metallic article, more particularly to a non-metallic article having a multi-color appearance. The invention also relates to a method for making the non-metallic article.

2. Description of the Related Art

Recently, a non-metallic material, such as a carbon fiber reinforced plastic material, an engineering plastic material, or the like, is used for various applications in view of its unique properties. For example, the carbon fiber reinforced plastic material is used to substitute for a metallic material and to make various sporting goods including fishing rods, golf club shafts, golf club heads, tennis rackets, badminton rackets, and similar articles, because of the properties such as lightweight, toughness, and elasticity. However, the article made of carbon fiber reinforced plastic material usually has a black appearance, which is not aesthetically pleasing. Therefore, various coating techniques were developed to provide a decorative, aesthetically pleasing appearance for the article.

Conventionally, a carbon fiber reinforced blank is applied with a base coating, a color coating, and a protective coating in sequence. However, the article made thereby cannot be provided with a metallic appearance, and the coatings are liable to be stripped from the article because of unsatisfactory bonding strength of the coatings.

U.S. Pat. No. 5,773,154 discloses an article having a decorative metal layer vapor deposited on a synthetic resin coating layer of the article by physical vapor deposition such as vacuum deposition, sputtering and ion plating. However, since the decorative metal layer is formed of a single metallic material, the appearance of the decorative metal layer is a singular color of the metal used for the decorative metal layer, and thus is monotonous and is devoid of a multi-color appearance.

### SUMMARY OF THE INVENTION

One object of the present invention is to provide a non-metallic article which has a multi-color metallic appearance.

Another object of the present invention is to provide a method for making the non-metallic article.

Accordingly, in one aspect of this invention, a non-metallic article includes a non-metallic substrate, a base coating, a metallic decorative coating, and a light-transmitting protective coating. The base coating includes a prime layer applied on the non-metallic substrate. The metallic decorative coating is deposited on the base coating, and includes a multi-color layer having a multi-color appearance. The multi-color layer is made of a cermet material produced by sputtering from a metal target using a gas mixture containing oxygen, nitrogen and hydrocarbon. The light-transmitting protective coating is applied on the metallic decorative coating.

In another aspect of this invention, a method for making a non-metallic article includes the steps of:

a) applying a prime layer on a non-metallic substrate;

b) depositing a multi-color layer on the prime layer by vacuum magnetron sputtering, the multi-color layer having a multi-color appearance and being made of a cermet material produced by sputtering from a metal target using a gas mixture containing oxygen, nitrogen and hydrocarbon; and

c) applying a light-transmitting protective coating on the multi-color layer.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic sectional view of the preferred embodiment of a non-metallic article according to this invention;

FIG. 2 is a flowchart of the preferred embodiment of a method for making a non-metallic article according to this invention;

FIG. 3 is a perspective partly sectional view of a vacuum magnetron sputtering system used for performing the method of the preferred embodiment;

FIG. 4 is a schematic view of the vacuum magnetron sputtering system performing a step of depositing a light reflective metallic layer; and

FIG. 5 is a schematic view of the vacuum magnetron sputtering system performing a step of depositing a multi-color layer.

### DETAILED DESCRIPTION OF THE PREFERRED EMBODIMENT

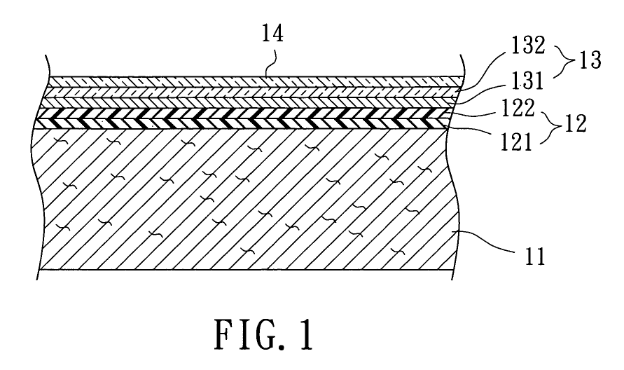

Referring to FIG. 1, the preferred embodiment of a non-metallic article according to this invention is shown to include a non-metallic substrate 11, a base coating 12, a metallic decorative coating 13, and a light-transmitting protective coating 14. The non-metallic article of this invention can be used for various sporting goods including fishing rods, golf club shafts, golf club heads, tennis rackets, badminton rackets, and similar articles.

In the preferred embodiment, the non-metallic substrate 11 is made of carbon fiber or plastic (such as an engineering plastic material, a polymeric material, or the like).

The base coating 12 includes a prime layer 121 applied evenly on the non-metallic substrate 11, and a varnish base layer 122 applied evenly on the prime layer 121 so as to enhance the evenness and the brightness of the base coating 12, preferably to a mirror-like extent. Alternatively, if the required brightness of the base coating 12 can be achieved by the prime layer 121, the varnish base layer 122 can be omitted.

The metallic decorative coating 13 is deposited on the base coating 12, and includes a light reflective metallic layer 131 disposed on the varnish base layer 122, and a multi-color layer 132 disposed on the light reflective metallic layer 131 and having a multi-color appearance. In the preferred embodiment, the light reflective metallic layer 131 is made of aluminum to enhance the brightness. It should be apparent to those skilled in the art that the light reflective metallic layer 131 can be made of other metals, such as titanium, chromium, iron, nickel, zirconium, and alloys thereof.

The multi-color layer 132 is made of a cermet material produced by sputtering from a metal target using a gas mixture containing oxygen, nitrogen and hydrocarbon. In the preferred embodiment, the metallic material is zirconium, and the hydrocarbon is methane or acetylene. Other metallic materials suitable for this invention include titanium, chromium, iron, nickel, aluminum, any alloys thereof.

Since the cermet material is a composite material composed of ceramic and metallic materials, it has the optimal properties of both a ceramic and a metal, such as a good combination of the properties including abrasive resistance, hardness, and cracking resistance.

It should be noted that the light reflective metallic layer 131 is used for enhancing the brightness. In practice, the multi-color appearance of the non-metallic article of this invention can be produced by the multi-color layer 132 without the light reflective metallic layer 131.

The multi-color metallic appearance exhibited by the multi-color layer 132 can be adjusted by changing the ratio of the metallic material to the gas mixture. Preferably, the multi-color layer 132 has a thickness ranging from 0.1 to 1 μm.

The light-transmitting protective coating 14 is applied on the multi-color layer 132 of the metallic decorative coating 13 so as to protect the multi-color layer 132 from scratching.

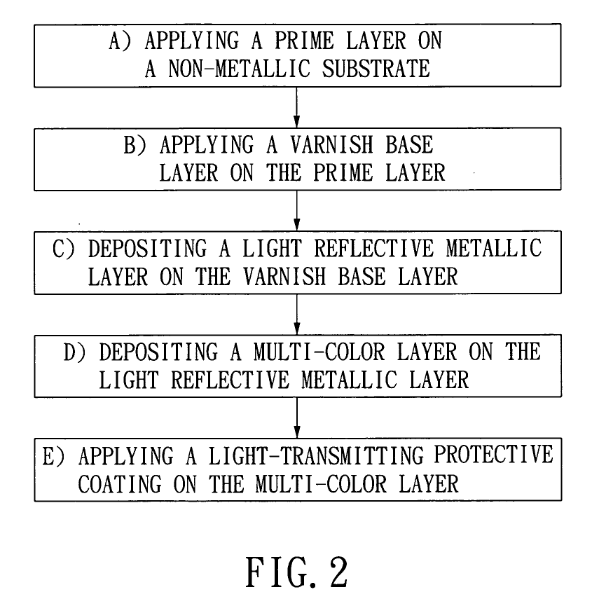

Referring to FIG. 2, the preferred embodiment of a method for making a non-metallic article according to this invention includes the steps of:

A) applying the prime layer 121 on the non-metallic substrate 11:

The prime layer 121 is applied evenly on the non-metallic substrate 11 by any suitable method well known in the art and is dried and cured by baking, irradiating with ultra-violet light, or the like. In the preferred embodiment, the prime layer 121 is an ordinary paint used in the art. It should be noted that, if required, the non-metallic substrate 11 can be pre-treated by polishing, grinding, or the like so as to enhance the quality of the prime layer 121 applied on the non-metallic substrate 11 thereafter.

B) applying the varnish base layer 122 on the prime layer 121:

The varnish base layer 122 is applied on the prime layer 121 by any suitable method well known in the art, and is dried and cured by baking, irradiating with ultra-violet light, or the like. In the preferred embodiment, the varnish base layer 122 is an ordinary paint used in the art. As described above, the varnish base layer 122 is used to enhance the evenness and the brightness of the base coating 12, preferably to a mirror-like extent. However, if the required brightness of the base coating 12 can be achieved by the prime layer 121, the step of applying the varnish base layer 122 can be omitted.

C) depositing the light reflective metallic layer 131 on the varnish base layer 122:

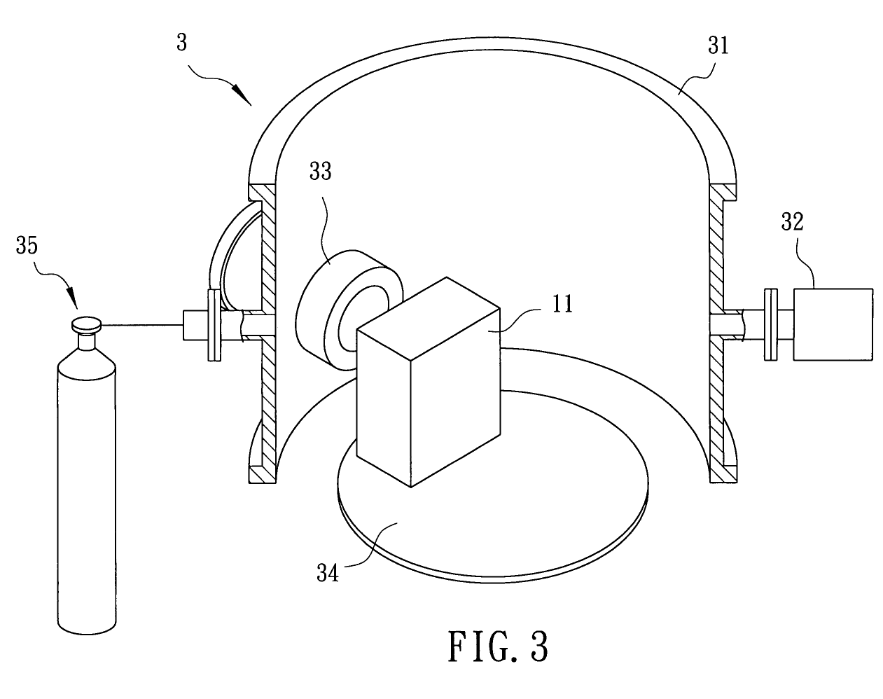

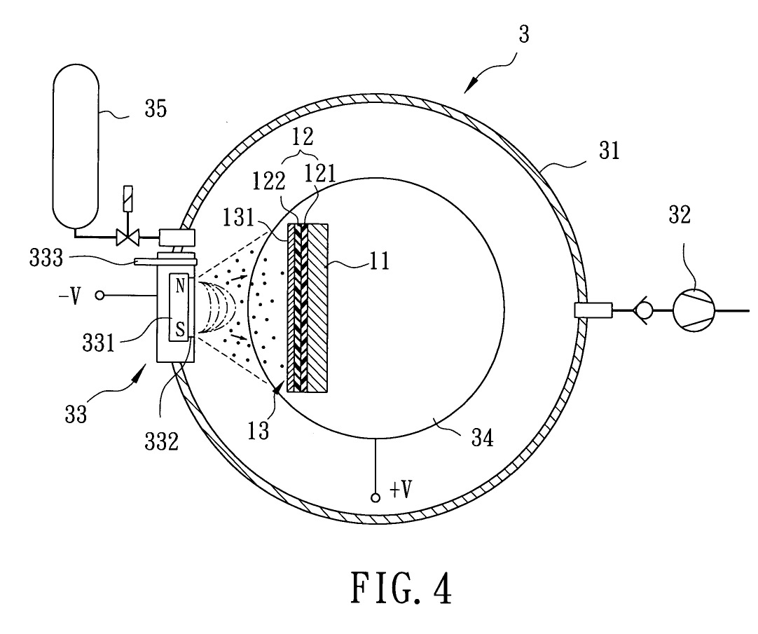

Referring to FIGS. 3 and 4, the light reflective metallic layer 131 is deposited on the varnish base layer 122 by vacuum magnetron sputtering. The vacuum magnetron sputtering is performed by a vacuum magnetron sputtering system 3.

The vacuum magnetron sputtering system 3 includes a vacuum chamber 31, an air-extracting unit 32 connected fluidly to the vacuum chamber 31, a sputtering unit 33 mounted on the vacuum chamber 31, a work carrier 34 disposed in the vacuum chamber 31 and corresponding to the sputtering unit 33, and a gas supplying unit 35 for supplying a gas mixture into the vacuum chamber 31.

The air-extracting unit 32 is used to extract air from the vacuum chamber 31 to permit the pressure in the vacuum chamber 31 to be lower than 1 atmosphere. The sputtering unit 33 includes a magnetic element 331, a metal target 332 mounted on the magnetic element 331, and a gas supplying element 333 for supplying inert gas into the vacuum chamber 31. In the preferred embodiment, the metal target 332 is made of aluminum. However, the metal target 332 can be made of other metallic materials, such as titanium, chromium, iron, nickel, zirconium, and alloys thereof according to the specific requirement. Preferably, the inert gas supplied by the gas supplying element 333 is argon. The work carrier 34 is used to carry the non-metallic substrate 11 to be deposited, and can be spinnable.

After the air in the vacuum chamber 31 is extracted by the air-extracting unit 32 to permit the air pressure in the vacuum chamber 31 to be lower than 7×10⁻¹ Pa, the argon supplied by the gas supplying element 333 is ionized under high voltage so as to produce plasma including argon ions, electrons, and neutral particles.

The metal target 332 is connected electrically to a negative electrode, and is supplied with a negative high voltage (−V) (for example, a negative voltage ranging from −300V to −800V). The work carrier 34 is connected electrically to a positive electrode (+V) or is connected to ground. The voltage difference between the metal target 332 and the work carrier 34 produces an electric field to accelerate the movement of argon ions onto the metal target 332. When the argon ions strike the metal target 332, an energy transfer occurs so that aluminum particles are sputtered out of the metal target 332 onto the non-metallic substrate 11 mounted on the work carrier 34 to deposit the light reflective metallic layer 131 on the varnish base layer 122.

The striking movement of the argon ions onto the metal target 332 can be controlled by the magnetic field produced by the magnetic element 331 so as to increase the sputtering rate.

It should be noted that the electrons can be constrained in the vicinity of the metal target 332 by the effect of the magnetic field, rather than striking onto the non-metallic substrate 11. Therefore, the temperature of the non-metallic substrate 11 is not increased so as to prevent deformation of the prime layer 121 and the varnish base layer 122. Preferably, the temperature of the prime layer 121 and the varnish base layer 122 is controlled to be below 150° C.

D) depositing the multi-color layer 132 on the light reflective metallic layer 131:

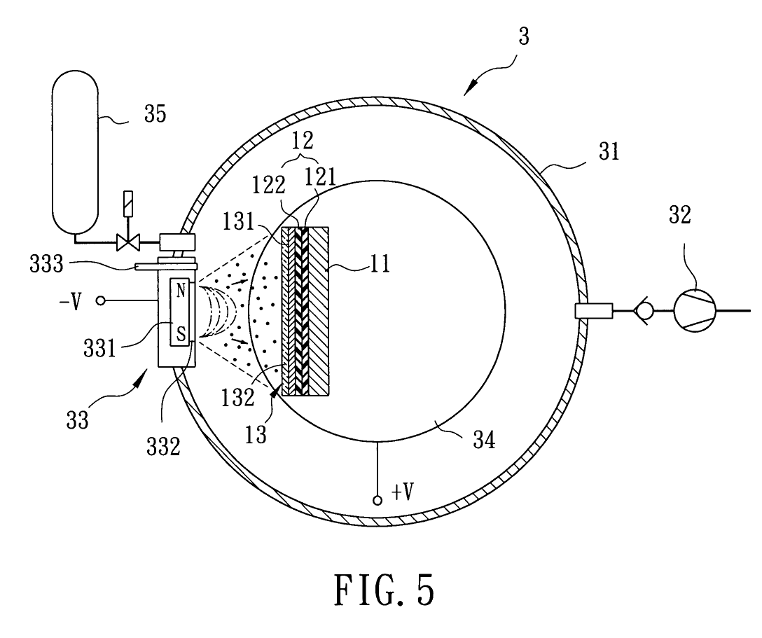

Referring to FIG. 5, the multi-color layer 132 is deposited on the light reflective metallic layer 131 similarly by the vacuum magnetron sputtering. In the preferred embodiment, the metallic target 332 made of zirconium is used in this step. However, the metal target 332 can be made of other metallic materials, such as titanium, chromium, iron, nickel, aluminum, and alloys thereof according to the specific requirement. After the argon ions are produced, the gas mixture including nitrogen, oxygen, and methane or acetylene is supplied into the vacuum chamber 31 from the gas supplying unit 35. Zirconium ions sputtering in the vacuum chamber 31 react with the gas mixture to produce a cermet compound deposited on the light reflective metallic layer 131 so as to form the multi-color layer 132 having a multi-color appearance.

It should be noted that the multi-color layer 132 can be even or non-even depending on the specific requirement so as to provide for a variety of multi-color appearances. The multi-color layer 132 having a non-even surface can be produced by interposing a shield plate (not shown) having an opening between the sputtering unit 33 and the work carrier 34. The technique for forming the multi-color layer 132 having a non-even surface is well known in the art, and thus is not described herein.

E) applying the light-transmitting protective coating 14 on the multi-color layer 132:

Referring once again to FIGS. 1 and 2, the light-transmitting protective coating 14 is applied on the multi-color layer 132 by any suitable method well known in the art and is dried and cured by baking, irradiating with ultra-violet light, or the like.

In view of the aforesaid, this invention has the following advantages:

1. Since the metallic decorative coating 13, which is composed of the light reflective metallic layer 131 and the multi-color layer 132, includes metallic materials, the non-metallic article of this present invention can be provided with a metallic decorative appearance.

2. The multi-color appearance exhibited by the metallic decorative coating 13 can be designed by adjusting the ratio of the metallic material to the gas mixture via controlling the sputtering rate of the metal target 332 and the flow rate of the gas mixture. Therefore, the multi-color appearance obtainable by the non-metallic article is relatively flexible.

3. Since the multi-color layer 132 of the metallic decorative coating 13 is made of cermet material, which is a composite material composed of ceramic and metallic materials, it has the optimal properties of both a ceramic and a metal, such as a good combination of the properties including abrasive resistance, hardness, and cracking resistance. Therefore, the durability of the non-metallic article of this invention is improved.

4. Since the light reflective metallic layer 131 and the multi-color layer 132 are deposited by vacuum magnetron sputtering, the adhesive strength and the evenness thereof can be improved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A non-metallic article, comprising:
a non-metallic substrate;
a base coating including a prime layer applied on said non-metallic substrate;
a metallic decorative coating deposited on said base coating, and including a multi-color layer having a multi-color appearance, said multi-color layer being made of a cermet material produced by sputtering from a metal target using a gas mixture containing oxygen, nitrogen and hydrocarbon; and
a light-transmitting protective coating applied on said metallic decorative coating.

2. The non-metallic article as claimed in claim 1, wherein said hydrocarbon is selected from the group consisting of methane and acetylene.

3. The non-metallic article as claimed in claim 1, wherein said base coating further includes a varnish base layer applied between said prime layer and said multi-color layer.

4. The non-metallic article as claimed in claim 3, wherein said metallic decorative coating further includes a light reflective metallic layer disposed between said varnish base layer and said multi-color layer.

5. The non-metallic article as claimed in claim 1, wherein said metal target is made of a metallic material selected from the group consisting of titanium, chromium, iron, nickel, zirconium, and aluminum.

6. The non-metallic article as claimed in claim 1, wherein said multi-color layer has a thickness ranging from 0.1 to 1 μm.

7. The non-metallic article as claimed in claim 1, wherein said non-metallic substrate is made of a material selected from the group consisting of carbon fiber and plastic.

8. A method for making a non-metallic article, comprising the steps of:
a) applying a prime layer on a non-metallic substrate;
b) depositing a multi-color layer on the prime layer by vacuum magnetron sputtering, the multi-color layer having a multi-color appearance and being made of a cermet material produced by sputtering from a metal target using a gas mixture containing oxygen, nitrogen and hydrocarbon; and
c) applying a light-transmitting protective coating on the multi-color layer.

9. The method as claimed in claim 8, further comprising a step of applying a varnish base layer on the prime layer prior to step b).

10. The method as claimed in claim 9, further comprising a step of depositing a light reflective metallic layer on the varnish base layer by vacuum magnetron sputtering prior to step b).

11. The method as claimed in claim 8, wherein the vacuum magnetron sputtering is conducted at a temperature below 150° C.
